(19) United States
(12) Patent Application Publication
(10) Pub. No.: US 2017/0349051 A1
(43) Pub. Date: Dec. 7, 2017

(54) System and Method for Recharging Power Storage Devices on a Watercraft

(71) Applicant: Edward Connell, Rancho Santa Margarita, CA (US)

(72) Inventor: Edward Connell, Rancho Santa Margarita, CA (US)

(21) Appl. No.: 15/605,925

(22) Filed: May 25, 2017

Related U.S. Application Data
(60) Provisional application No. 62/346,112, filed on Jun. 6, 2016.

(51) Int. Cl. B60L 11/18; F03B 17/06; B63B 9/04; B63J 3/04; H02K 7/18; B63B 3/14; B63J 3/00

(52) U.S. Cl. CPC B60L 11/1809; H02K 7/1823; F03B 17/062; B63B 3/14; B63B 9/04; B63J 3/04; B63J 2003/002; B60L 2200/32; F05B 2220/32; F05B 2220/706; F05B 2240/931

(57) ABSTRACT

A system for recharging power storage devices on a watercraft is disclosed herein. The system for recharging power storage devices on a watercraft includes a shell, at least one linear-channel fixedly mounted inside the shell, a turbine having at least one rotor and at least one shaft connected to the rotor, and a generator. The system for recharging power storage devices on a watercraft is useful for converting the rotational energy provided by the water flowing past the turbine rotor into electrical energy to charge a power storage device on a watercraft.

### CROSS-REFERENCE TO RELATED APPLICATION

The present application is related to and claims priority to U.S. Provisional Patent Application No. 62/346,112 filed Jun. 6, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of ships and more specifically relates to fluid-current motors.

### 2. Description of Related Art

As the human population grows, more and more people are becoming acutely aware of the environmental impact we have on the world. Vehicles powered by fossil fuels are a large contributor to harmful emissions in our environment. For the last twenty years, motor vehicle manufacturers have produced a wide variety of hybrid vehicles to combat the emissions of the internal combustion engine. A hybrid vehicle uses multiple distinct types of power to power the vehicle such as an internal combustion engine and an electrical engine in combination.

While motor vehicles such as passenger cars have been quick to adopt the hybrid trend, many other types of motor vehicles are still behind the curve. One such motor vehicle is watercraft such as boats, ships, and yachts. Watercraft in general tend to consume much more fuel than motor vehicles for land. Furthermore, many watercraft used for commercial purposes such as fishing and shipping have been in service for many years and have outdated, less fuel-efficient engines. The cost of replacing the outdated technology in these watercraft is often obviated by the price of purchasing an entirely new watercraft. A suitable solution is desired.

U.S. Pat. No. 6,508,191 to Raymond Spoljaric relates to an Aqua Turbo Generator. The described Aqua Turbo Generator includes an underwater generator for use with a surface vessel, having a cylindrical housing with two major parts: a turbine and a generator. The turbine is located in the front portion of the device and is connected to the generator in the rear of the device through a set of gears. A conical shaped filter pointed forward is located in the front of the turbine to prevent clogging of the device. The size of the filter rib openings is smaller than the spacing between the turbine blades so that any particulate matter that passes through the filter can freely pass through the turbine and out the housing. At the junction between the conical filter and the main body of the housing, the water is deflected into the housing by a special deflector thus forcing the water to pass through the turbine. A water flow passage is provided for a water outlet and a leak proof enclosure surrounds the turbine, gears and generator. The housing is connected to the vessel by way of mounting frame.

### BRIEF SUMMARY OF THE INVENTION

In view of the foregoing disadvantages inherent in the known ships art, the present disclosure provides a novel system and method for recharging power storage devices on a watercraft. The general purpose of the present disclosure, which will be described subsequently in greater detail, is to provide a system and method for recharging power storage devices on a watercraft.

A system and method for recharging power storage devices on a watercraft is disclosed herein. The system and method for recharging power storage devices on a watercraft includes a shell, at least one channel fixedly mounted inside the shell, a turbine and a generator.

According to another embodiment, a system and method for recharging power storage devices on a watercraft is also disclosed herein. The system and method for recharging power storage devices on a watercraft includes a shell configured to cover the hull of a watercraft from a bow of the watercraft to a stern of the watercraft at least partially below the waterline on a watercraft.

The system also includes at least one linear channel, horizontally positioned and traversing the length of the shell. The system may further comprise a turbine positioned within the engine room of the watercraft and a generator positioned within the engine room of the watercraft. According to this embodiment, the shell comprises at least one fastener configured to fixedly attach the shell to the hull of the watercraft. The linear-channel is tapered directionally toward the stern of the watercraft, the linear-channel including a first-opening configured to allow water to enter the linear-channel and a second-opening configured to allow expulsion of water from the linear-channel, and a chamber centrally located along the length of the linear-channel. The chamber may comprise at least one opening to allow water to enter the chamber from the linear-channel and at least one opening to allow water to exit the chamber into the linear-channel.

According to this embodiment, the system provides a turbine having at least one rotor which is housed by the chamber of the linear-channel. The rotor further comprises a shaft which extends from the center of the rotor, through the shell, through the hull of the watercraft into the turbine. The turbine is further communicatively coupled to the generator.

According to another embodiment, a method for recharging power storage devices on a watercraft is also disclosed herein. The method for recharging power storage devices on a watercraft may include the steps of: installing a shell of a system for recharging power storage devices onto a bottom of the watercraft, channeling water into a channel of the shell via forward movement of the watercraft, rotating a rotor positioned along the channel via passing water, generating kinetic energy via a rotational force of the rotor caused by the passing water, converting potential energy into kinetic energy via a generator to produce electrical current, storing the electrical current to charge a power storage device, and channeling water outside the channel of the shell via at least one exit port.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system and method for recharging power storage devices on a watercraft, constructed and operative according to the teachings of the present disclosure.

FIG. 1 is a perspective view of the system and method for recharging power storage devices on a watercraft during an ‘in-use’ condition showing water entering a channel of a shell which may be harnessed for hydropower, according to an embodiment of the disclosure.

FIG. 2 is a perspective view of the system and method for recharging power storage devices on the watercraft of FIG. 1, according to an embodiment of the present disclosure.

FIG. 3 is a top view of the system and method for recharging power storage devices on a watercraft of FIG. 1, according to an embodiment of the present disclosure.

FIG. 4 is a top perspective view of the system and method for recharging power storage devices on a watercraft of FIG. 1, according to an embodiment of the present disclosure.

FIG. 5 is a flow diagram illustrating a method of use for the system and method for recharging power storage devices on a watercraft, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fluid-current motor and more particularly to a system and method for recharging power storage devices on a watercraft as used to improve the production of usable energy on watercrafts.

Generally, the present invention provides a system and method for recharging power storage devices on a watercraft. The present invention aims to provide a method to manufacture or attach a device to the hull of a watercraft below the waterline that is configured to funnel incoming water into a turbine to produce electricity. The funnel may advantageously decrease in size as it traverses the length of the watercraft, pressurizing the water before it is expelled into a chamber housing a rotor. The pressurized water imparts its energy on the rotor, rotating the blades of the rotor and rotating a shaft which is connected at one end to the rotor. At the opposite end of the shaft there is a generator attached to convert the rotational energy of the turbine into electrical energy which can then be stored in a power storage device and used by the electrical engine of the watercraft.

The system and method for recharging power storage devices on a watercraft may be configured to retrofit onto an existing watercraft to provide hybrid-electric power to a watercraft. The retrofit embodiment of the system may be removably or permanently fixable to the hull of a watercraft. The system may also be manufactured into the hulls of newly manufactured watercraft to provide an additional, optional power source for a watercraft. The size of the components of the present invention may vary based upon the size of the watercraft to which they are being applied.

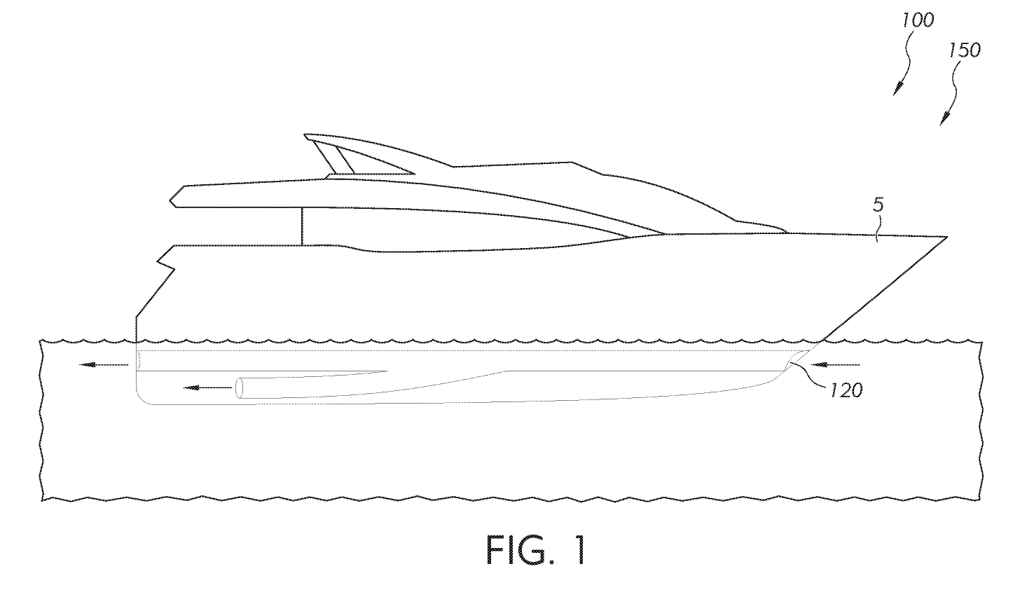

Referring now more specifically to the drawings by numerals of reference, there is shown in FIGS. 1-4, various views of a system 100 and method 500 for recharging power storage devices on a watercraft 5. FIG. 1 shows the system 100 for recharging power storage devices on a watercraft 5 during an ‘in-use’ condition 150, according to an embodiment of the present disclosure. Here, the system 100 may be beneficial for use by a user 140 to produce usable energy on watercraft 5 when the watercraft 5 is ‘in use’ traversing through water.

As shown, the system 100 for recharging power storage devices on the watercraft 5 may include a shell 110, the shell 110 having a front, a rear, a first side, a second side, a bottom, and an open top, the open top dimensionally configured to encase a hull of the watercraft 5. The invention may further comprise at least one linear-channel 120 fixedly mounted inside the shell 110. The linear-channel(s) 120 may be horizontally positioned and traverse the length of the shell 110. The linear-channel(s) 120 is/are tapered directionally toward the stern of the watercraft 5. The linear-channel(s) 120 may comprise a first-opening configured to allow water to enter the linear-channel 120 and a second-opening configured to allow expulsion of water from the linear-channel 120.

According to one embodiment, the system 100 for recharging power storage devices on a watercraft 5 may be arranged as a kit 105. In particular, the system 100 for recharging power storage devices on a watercraft 5 may include a set of instructions 155. The instructions 155 may detail functional relationships in relation to the structure of the system 100 and method 500 for recharging power storage devices on a watercraft 5 (such that the 100 and method 500 for recharging power storage devices on a watercraft 5 can be used, maintained, or the like, in a preferred manner). The kit 105 may be useful for retrofit installment of the shell 110 having at least one linear-channel 120 on a watercraft 5.

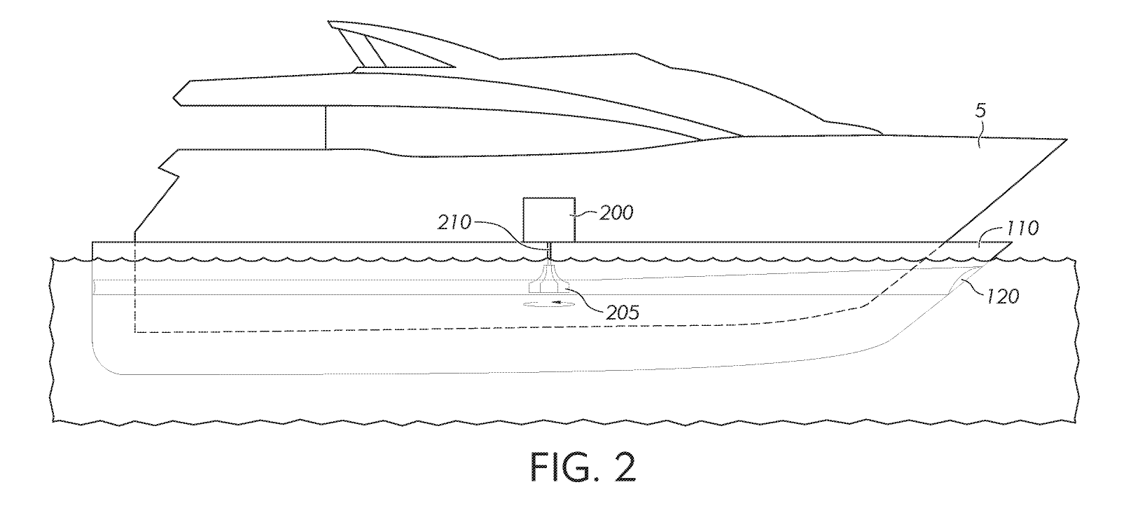

FIG. 2 shows the system 100 for recharging power storage devices on a watercraft 5 of FIG. 1, according to an embodiment of the present disclosure. As above, the system 100 may include the shell 110 including at least one linear-channel 120 horizontally positioned and traversing the length of the shell 110.

In continuing to refer to FIG. 2, the linear-channel(s) 120 may further comprise a centrally located chamber 130. The chamber 130 may be positioned in abutment to the narrowest point of the linear-channel 120 and includes at least one opening to allow water to enter the chamber 130 from the linear-channel 120. Further, the linear-channel 120 may comprise at least one opening to allow water to exit the chamber 130 into the linear-channel 120. The chamber 130 encloses a rotor 205 which is attached to a shaft 210.

In continuing to refer to FIG. 2, the system 100 may further comprise a turbine 200. The turbine 200 comprises the rotor 205 and the shaft 210. The turbine 200 is positioned such that water flowing through the linear-channel 120 is directed toward the rotor 205 at high pressure. The water imparts its energy on the rotor 205, rotating it and in turn, rotating the attached shaft 210.

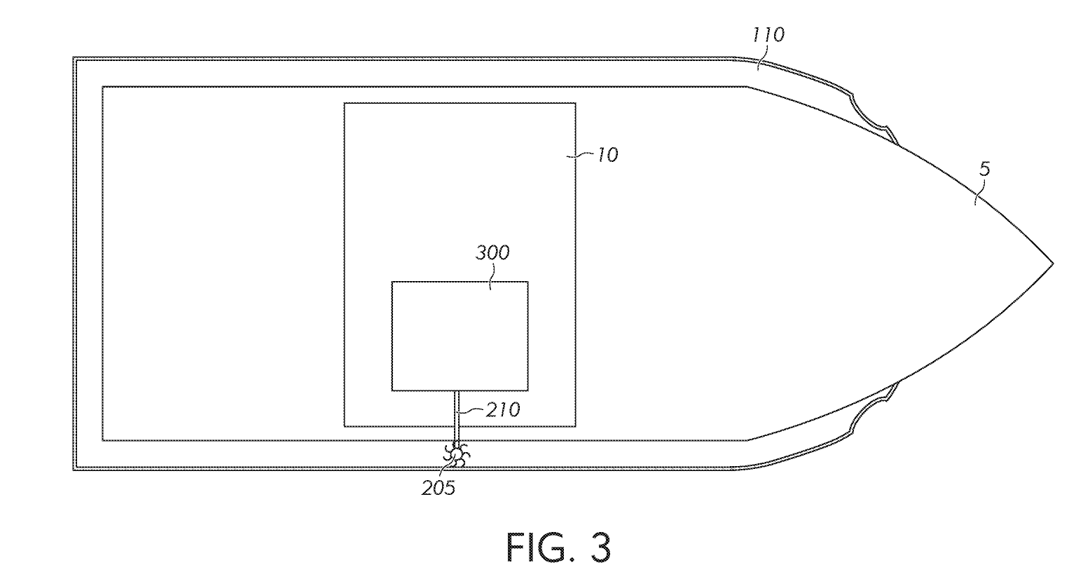

FIG. 3 is a top view of the system 100 and method 500 for recharging power storage devices on a watercraft 5 of FIGS. 1-2, according to an embodiment of the present disclosure. As above, the system 100 may include a tapered, linear-channel 120 which directs water toward a turbine 200. The turbine 200 comprises the rotor 205 and the shaft 210. The shaft 210 extends from the center of the rotor 205, through the shell 110, through the hull of the watercraft 5 into the turbine 200. The configuration of the shaft 210 and rotor 205 provide a means for the turbine 200 to harness the energy of the water passing through the linear-channel 120.

Preferably, the turbine 200 further comprises a housing which contains the components of the turbine 200 and which may be located in or adjacent to the engine room 10 of a watercraft 5. This arrangement allows for efficient conversion of the rotational energy from the turbine 200 into electrical energy. The turbine 200 may further include various gearing to increase or decrease the speed of rotation or reverse the direction of the rotational energy provided by the rotor 205. Furthermore, the turbine 200 may include gearing to transmit the rotational energy provided by the rotor 205 to a different axis to suit the generator 300 to which the energy is being supplied.

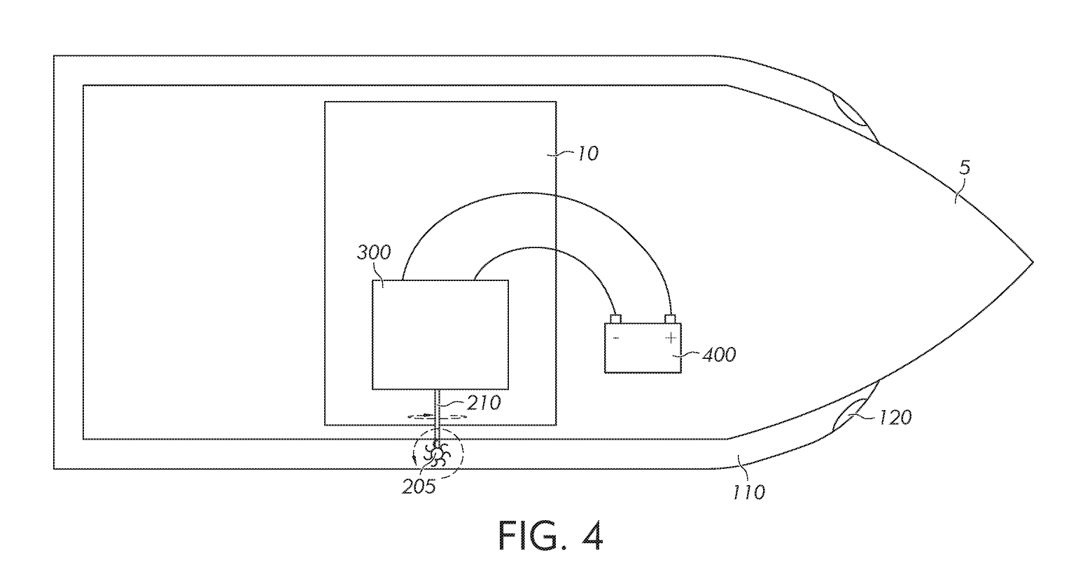

FIG. 4 is a top perspective view of the system 100 and method 500 for recharging power storage devices on a watercraft 5 of FIGS. 1-3, according to an embodiment of the present disclosure. As above, the system 100 may include the turbine 200. The turbine 200 is communicatively coupled to a generator 300 configured to convert kinetic energy into electrical energy. The generator 300, which may be located in or adjacent to the engine room 10 of a watercraft 5, may harness the rotational energy supplied by the turbine 200 and convert it to electrical energy through electromagnetic induction.

The rotational energy provided by the turbine 200 may move an electrical conductor such as a wire containing electric charges in a magnetic field to convert the energy into electricity. The electricity produced by the generator 300 may then be used to charge a power storage device 400 on a watercraft 5 for storage for later use. Furthermore, the electricity produced by the generator 300 may be used to directly power an electrical engine or other electrical systems in the watercraft 5.

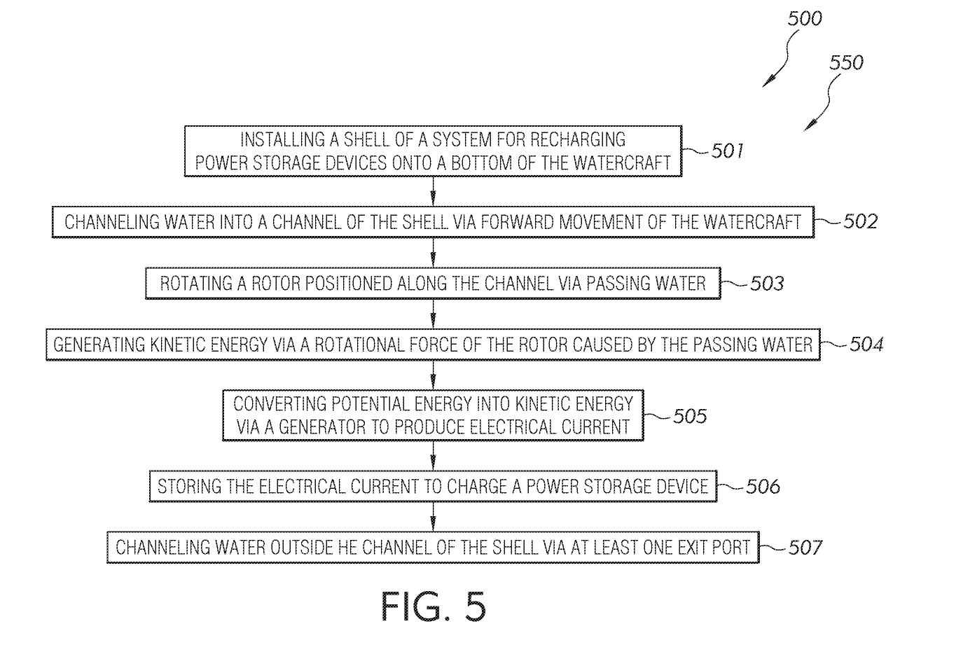

FIG. 5 is a flow diagram 550 illustrating a method of use 500 for recharging power storage devices 400 on a watercraft 5, according to an embodiment of the present disclosure. In particular, the method 500 for recharging power storage devices on a watercraft 5 may include one or more components or features of the system 100 for recharging power storage devices on a watercraft 5 as described above. As illustrated, the method of use 500 may include the steps of: step one 501, installing a shell 110 onto a bottom of the watercraft 5; step two 502, channeling water into at least one linear-channel 120 of the shell 110 via forward movement of the watercraft 5; step three 503, rotating a rotor 205 positioned along the at least one linear-channel 120 via passing water; step four 504, generating kinetic energy via a rotational force of the rotor 205 caused by the passing water; step five 505, converting potential energy into kinetic energy via a generator 300 to produce electrical current; step six 506, storing the electrical current to charge a power storage device 400; and step seven 507, channeling water outside the at least one linear-channel 120 of the shell 110 via at least one exit port.

It should be noted that step six 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for recharging power storage devices on a watercraft (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for recharging power storage devices on a watercraft, the system comprising:
a shell, the shell having a front, a rear, a first side, a second side, a bottom, and an open top, the open top dimensionally configured to encase a hull of the watercraft;
at least one channel fixedly mounted inside the shell;
a turbine having an encasement, the encasement coupled to the shell via at least one shaft, the turbine in communication with the at least one channel, the turbine including a rotor configured to rotate and produce kinetic energy; and
a generator configured to convert the kinetic energy into electric energy to charge at least one power storage device.

2. The system of claim 1, wherein the shell is configured to cover the hull of the watercraft from a bow of the watercraft to a stern of the watercraft at least partially below the waterline on the watercraft.

3. The system of claim 1, wherein the shell comprises at least one fastener configured to fixedly attach the shell to the hull of the watercraft.

4. The system of claim 1, wherein the shell comprises at least one fastener configured to removably attach the shell to the hull of the watercraft.

5. The system of claim 1, wherein the shell further comprises at least one linear-channel horizontally positioned and traversing the length of the shell.

6. The system of claim 5, wherein the linear-channel is tapered directionally toward the stern of the watercraft.

7. The system of claim 6, wherein the linear-channel comprises a first-opening configured to allow water to enter the linear-channel.

8. The system of claim 7, wherein the linear-channel comprises a second-opening configured to allow expulsion of water from the linear-channel.

9. The system of claim 8, wherein the linear-channel comprises a chamber which encloses the rotor.

10. The system of claim 9, wherein the chamber is positioned in abutment to the narrowest point of the linear-channel.

11. The system of claim 9, wherein the chamber includes at least one opening to allow water to enter the chamber from the linear-channel.

12. The system of claim 9, wherein the chamber includes at least one opening to allow water to exit the chamber into the linear-channel.

13. The system of claim 9, wherein the shaft extends from the center of the rotor, through the shell, through the hull of the watercraft into the turbine.

14. The system of claim 13, wherein the turbine is positioned within the engine room of the watercraft.

15. The system of claim 1, wherein the generator is positioned within the engine room of a watercraft.

16. The system of claim 14, wherein the turbine is communicatively coupled to the generator to convert kinetic energy into electrical energy.

17. A system for recharging power storage devices on a watercraft, the system comprising:
a shell, the shell having a front, a rear, a first side, a second side, a bottom, and an open top, the open top dimensionally configured to encase a hull of the watercraft;
a first linear-channel fixedly mounted inside the shell along the first side;
a second linear-channel fixedly mounted inside the shell along the second side;
a turbine having an encasement, the encasement coupled to the shell via at least one shaft, the turbine in communication with the first linear-channel and the second linear-channel, the turbine including a rotor configured to rotate and produce kinetic energy; and
a generator configured to convert the kinetic energy into electric energy to charge at least one power storage device;
wherein the shell is configured to cover the hull of the watercraft from a bow of the watercraft to a stern of the watercraft at least partially below the waterline on the watercraft;
wherein the shell comprises at least one fastener to fixedly or removably attach the shell to the hull of a watercraft;
wherein the shell comprises at least one linear-channel horizontally positioned and traversing the length of the shell;
wherein the first linear-channel and the second linear-channel are tapered directionally toward the stern of the watercraft;
wherein the first linear-channel and the second linear-channel each comprises at least one water intake opening near the front of the shell;
wherein the first linear-channel and the second linear-channel each comprises a water expulsion opening configured to allow expulsion of water from the first linear-channel and the second linear-channel;
wherein the system further includes a chamber configured to house the rotor;
wherein the chamber includes at least one opening to allow water to enter the chamber;
wherein the chamber includes at least one opening to allow water to exit the chamber;
wherein the turbine is communicatively coupled to the generator to convert kinetic energy into electrical energy.

18. The system of claim 17, wherein the shell is structured and arranged to be retrofittable onto an existing watercraft after manufacturing.

19. The system of claim 17, wherein the shell is structured and arranged to be manufactured directly into a watercraft.

20. A method of generating power on a watercraft, the method comprising the steps of:
installing a shell of a system for recharging power storage devices onto a bottom of the watercraft channeling water into a channel of the shell via forward movement of the watercraft;
rotating a rotor positioned along the channel via passing water;
generating kinetic energy via a rotational force of the rotor caused by the passing water;
converting potential energy into kinetic energy via a generator to produce electrical current;
storing the electrical current to charge a power storage device; and
channeling water outside the channel of the shell via at least one exit port.
